(19) United States
(12) Patent Application Publication
(10) Pub. No.: US 2002/0035580 A1
(43) Pub. Date: Mar. 21, 2002

(54) Computer readable medium containing HTML document generation program

(76) Inventor: Yoshinori Tanabe, Kawasaki (JP)

Correspondence Address: STAAS & HALSEY LLP, 700 11TH STREET, NW, SUITE 500, WASHINGTON, DC, 20001, US

(21) Appl. No.: 09/823,969

(22) Filed: Apr. 3, 2001

(30) Foreign Application Priority Data
Sep. 21, 2000 (JP) 2000-287303

(51) Int. Cl. G06F 17/21; G06F 17/22

(52) U.S. Cl. 707/513; 707/530

(57) ABSTRACT

Even if an extended HTML document incorporating an extended tag is converted by an HTML editor into a document contrary to the original intent of the operator, an HTML document generation device 3 performs preprocessing on the converted document and restores the document to a state which reflects the intent of the operator. Moreover, the generation device 3 generates a normal HTML document containing no extended tags by searching a database 22 in accordance with the specifications of any extended tags included in the HTML document.

### BACKGROUND OF THE INVENTION

1. Field of the Invention

The present invention relates to a computer readable medium which contains an HTML document generation program for generating a normal HTML document based on an extended HTML document including extended tags which are not prescribed in the syntax of the HTML.

2. Description of the Related Art

HTML (Hypertext Markup Language) is widely used as a page description language on both the Internet and in intranet environments. The data (HTML document) written in the HTML is displayed on a screen by a WWW (World Wide Web) browser. Extended tags are used within these HTML documents for incorporating external data. For example the external data is retrieved from a database. The extended tag is not a formal HTML tag, but is described in a form resembling the formal tag.

HTML documents incorporating such extended tags (extended HTML documents) are processed by an HTML document generation device. More specifically, the generation device retrieves necessary information from the database in accordance with the specifications of the extended tags included in the extended HTML document, and then generates a new HTML document based on the retrieved data. The newly generated HTML document contains no extended tags.

Extended tags are classified into first type extended tags and second type extended tags, depending on the processing performed by the generation device based on them. The first type extended tag does not develop into text by the generation device. In contrast, the second type extended tag does develop into text by the generation device.

FIG. 1 is a diagram showing an example of the first type extended tag. In the figure, <!IF “t==0“>, <!ELSE>, and <!/IF> are all first type extended tags. The extended HTML document shown in FIG. 1 is converted by the generation device into either the HTML document of FIG. 2A or the HTML document of FIG. 2B. If the variable t in the database has a value of 0 then the HTML document of FIG. 2A is generated, whereas for any other value the HTML document of FIG. 2B is generated.

The extended tag shown in FIG. 1 specifies that depending on the value of the variable t in the database, either the data between <!IF “t==0”> and <!ELSE> or the data between <!ELSE> and <!/IF> is selected. The extended tag itself does not appear in the text.

FIG. 3 is a diagram showing an example of the second type extended tags. In the figure, <!REPLACE x> is a second type extended tag. The generation device replaces the second type extended tag with the value of the variable x from the database operating language. For example, if the value of the variable x is 500, then <!REPLACE x> is replaced with 500, and consequently the HTML document shown in FIG. 4 is generated. This means that the second type extended tag develops into text.

HTML documents shown in FIG. 2A, FIG. 2B and FIG. 4, which have been output from the generation device, contain no extended tags. Consequently, these HTML documents can be displayed correctly on a screen by a WWW browser.

As described above, if an extended HTML document is created in a form shown in FIG. 1 and FIG. 3, then the generation device can correctly process the extended HTML document. Although a text editor can be used to create these extended HTML documents, an HTML editor is typically used. The HTML editors have a correction function. Because of the correction function, data input by an operator is corrected in accordance with the HTML syntax. The correction function is useful to create typical HTML documents. However, when the operator creates extended HTML documents including the extended tags described above, the correction function causes problems described below.

First is a problem which arises when an HTML tag pair such as <UL></UL> which can involve an element between a start tag and an end tag involves the first type extended tag as the element. For example, some HTML editors will convert the extended HTML document shown in FIG. 1 into the extended HTML document shown in FIG. 5.

According to the syntax of the HTML, the region bracketed the start tag <UL> and the end tag </UL> should contain a list enclosed by the lower level tag pair <LI> and </LI>. Consequently, the HTML editor recognizes the extended tags <!IF “t==0”>, <!ELSE>, and <!/IF> as lists, and adds <LI> and </LI> before and after each of the extended tags. As a result the tags <!IF “t==0”>, <!ELSE>, and <!/IF> are converted to <LI><! IF “t==0”></LI>, <LI><!ELSE></LI>, and <LI><!/IF></LI> respectively, and consequently the HTML document generation device is unable to generate the new HTML documents of FIG. 2A and FIG. 2B based on the extended HTML document edited by the HTML editor.

Furthermore, some HTML editors convert the extended HTML document shown in FIG. 3 into the extended HTML document shown in FIG. 6. More specifically, according to the HTML syntax, the region between a tag pair relating to a character style (such as the region between a start tag <EM> and an end tag </EM>) should contain text. As a result, the HTML editor may make the assessment that a second type extended tag <!REPLACE x> resembling an HTML tag should not follow immediately after the tag <EM>. The HTML editor then inverts the order of <EM> and <!REPLACE x>. As shown in FIG. 6, such an inversion of order means that only the text “yen” exists between <EM> and </EM>. The extended HTML document of FIG. 6 will be converted by the generation device into the HTML document 500<EM>yen</EM>. In the document the character style (EM: emphasize) will be applied not to the text portion “500yen,” but rather only to the text portion “yen.”

It resolves the problems described above to develop an HTML editor which correctly recognizes the extended tags. However, it is not realistic to replace each of the various HTML editors in current usage with the HTML editor which can recognize the extended tags.

### SUMMARY OF THE INVENTION

An object of the present invention is to provide a computer readable medium containing an HTML document generation program able to process an extended HTML document which have been edited by a conventional HTML editor.

An HTML document generation program according to the present invention is executed by a computer. The HTML document generation program comprises a first HTML document generation program for processing a first type extended tag which is defined that the tag itself does not develop into text, and a second HTML document generation program for processing a second type extended tag which is defined that the tag itself develops into text.

The first HTML document generation program controls the computer to read the aforementioned HTML document. In those cases where an HTML tag pair which may include elements in a predetermined form between a start tag and an end tag actually includes only an element described by a first type extended tag, or alternatively includes no elements at all, then by treating the tag pair as nonexistent, the program causes the computer to recognize the presence of a first type extended tag, and then causes the computer to generate an HTML document in accordance with the specifications of the first type extended tag but which does not contain the first type extended tag.

By treating those HTML tags inserted by the HTML editor against the intent of the operator as nonexistent, the first HTML document generation program is able to make the computer recognize first type extended tags in the way the operator intended. As a result, an HTML document is generated which matches the original intent of the operator.

The second HTML document generation program, in those cases where a second type extended tag is positioned between an HTML start tag and end tag pair relating to a character style, causes the computer to read an HTML document in which arbitrary text is added immediately after the start tag relating to the a character style and immediately prior to the end tag relating to the character style, and in which each set of tags and text relating to the character style is described by being enclosed by a predetermined identification extended tag pair, and by assuming that no text exists in the region enclosed by the identification extended tag pair, and moreover that the identification extended tag pair itself does not exist. The program causes the computer to recognize the tags relating to the character style, and then causes the computer to generate an HTML document in accordance with the specifications of the second type extended tag but which does not contain the second type extended tag.

Provided identification extended tags and arbitrary text is added to those tags within the HTML document relating to the character style, then even if the HTML document is converted by an HTML editor to a document contrary to the intent of the operator, the second HTML document generation program is able to ensure that the tags relating to the character style behave correctly in relation to a second type extended tag. As a result, if the second type extended tag is converted to a text, then the tag relating to the character style acts upon that text in the correct manner.

### BRIEF DESCRIPTION OF THE DRAWINGS

The invention will be described below in detail with reference to the accompanying drawings, in which:

FIG. 1 is a sample HTML document input by an operator;

FIG. 2 is a sample HTML document generated by an HTML document generation device;

FIG. 3 is a sample HTML document input by an operator;

FIG. 4 is a sample HTML document generated by an HTML document generation device;

FIG. 5 is a sample HTML document converted by an editor device;

FIG. 6 is a sample HTML document converted by an editor device;

FIG. 7 is a system configuration diagram according to an embodiment of the present invention;

FIG. 8 is a sample HTML document input by an operator;

FIG. 9 is a sample HTML document converted by an editor device;

FIG. 10 is a table showing structural tags and element tags;

FIG. 11 is a table showing first type extended tags;

FIG. 12 is a flowchart showing preprocessing performed by an HTML document generation device;

FIG. 13 is a parse tree created based on FIG. 5;

FIG. 14 is a parse tree converted from FIG. 13;

FIG. 15 is a parse tree converted from FIG. 14;

FIG. 16 is a parse tree created based on FIG. 9;

FIG. 17 is a parse tree converted from FIG. 16;

FIG. 18 is a flowchart showing the processing of S2 of FIG. 12;

FIG. 19 is a sample HTML document input by an operator;

FIG. 20 is a sample HTML document converted by an editor device;

FIG. 21 is a parse tree created based on FIG. 20;

FIG. 22 is a parse tree converted from FIG. 21;

FIG. 23 is a parse tree converted from FIG. 22;

FIG. 24 is a parse tree converted from FIG. 23;

FIG. 25 is a parse tree converted from FIG. 24;

FIG. 26 is a sample HTML document generated by an HTML generation device; and

FIG. 27 is a flowchart showing the processing of S5 of FIG. 12.

### DESCRIPTION OF THE PREFERRED EMBODIMENT

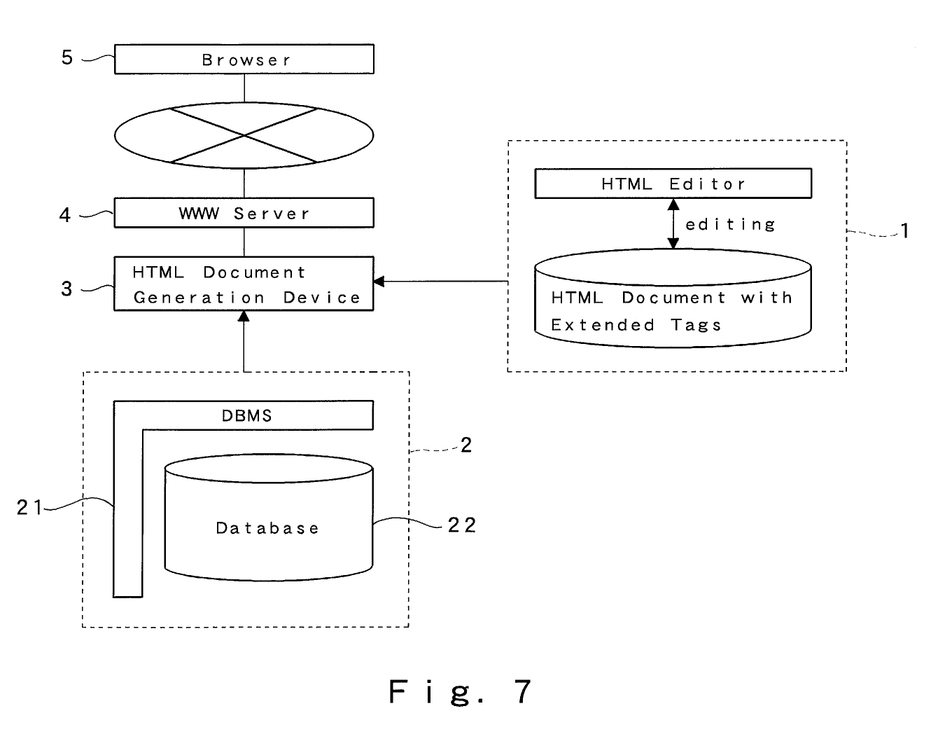

An embodiment of the present invention will be described with reference to the drawings. FIG. 7 is a system configuration diagram of the embodiment. The system comprises an editor device 1, a database device 2, an HTML document generation device 3, a WWW server device 4, and a WWW browser device 5, each of which comprises a computer such as a personal computer or workstation.

The editor device 1 comprises a HDD in which an HTML editor program has been preinstalled. An operator creates an HTML document using the editor device 1 with the HTML editor program operating therein.

The database device 2 also comprises a HDD in which a database management system (DBMS) 21 has been preinstalled and a database 22 has been constructed.

The HTML document generation device 3 comprises a HDD, which corresponds with a computer readable medium. An HTML document generation program for processing extended tags has been preinstalled in the HDD of the generation device 3. The HTML document generation program incorporates a module for processing a first type extended tag (a first HTML document generation program) and a module for processing a second type extended tag (a second HTML document generation program). The generation device 3 is connected to both the editor device 1 and the database device 2.

The generation device 3 acquires an extended HTML document from the editor device 1, and performs the preprocessing described below on the extended HTML document. In addition, the generation device 3 also refers to the database 22 in accordance with the specifications of extended tags included in the preprocessed document. Then, the generation device 3 retrieves data from the database 22 to generate a normal HTML document, which includes no extended tags.

The server device 4 comprises a HDD in which a WWW server program has been preinstalled. The server device 4 is connected to the generation device 3. The server device 4 acquires the HTML document generated by the generation device 3 to store the acquired document in the HDD of the server device 4.

The browser device 5 also comprises a HDD in which a WWW browser program has been preinstalled. The browser device 5 is connected to the server device 4 via a network such as the Internet or an intranet. The browser device 5 acquires the HTML document from the server device 4 to display the acquired document on the display of the browser device 5.

Moreover, the HTML editor program installed on the editor device 1 is unable to treat extended tags correctly. Consequently, if the operator inputs the HTML document of FIG. 1, containing the first type extended tag, into the editor device 1, the editor device 1 will convert the input HTML document into the document shown in FIG. 5. The HTML document of FIG. 5 differs from the original intent of the operator.

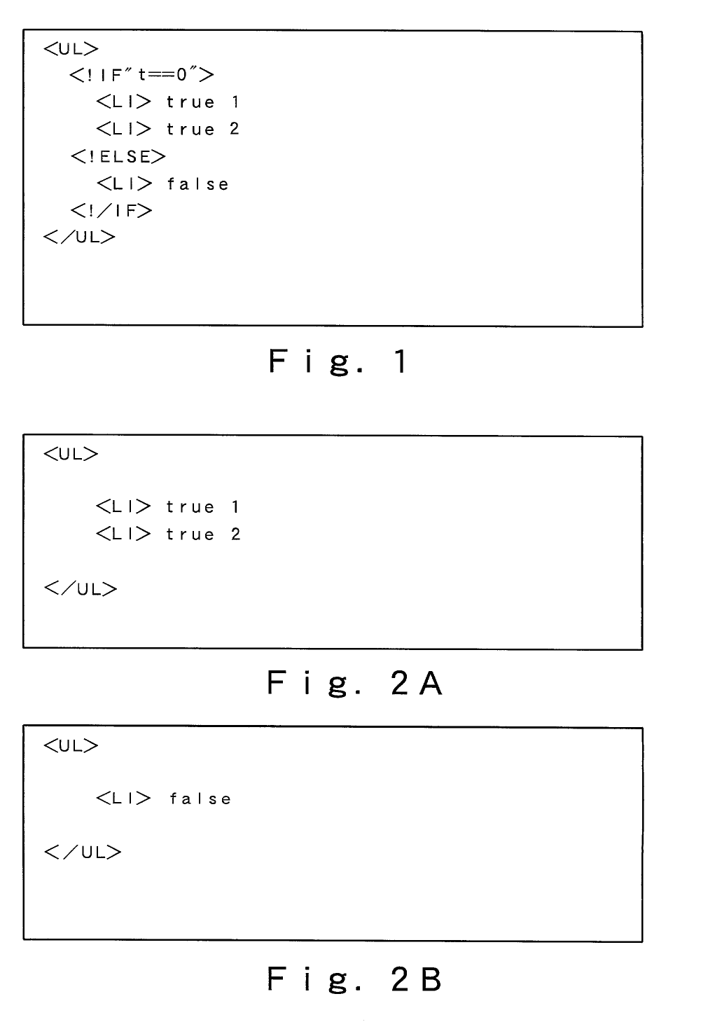

By performing the preprocessing described below on the HTML document of FIG. 5, the generation device 3 of the present embodiment can acquire the substantially same HTML document as that shown in FIG. 1. In addition, the generation device 3 processes the extended tags in the HTML document of FIG. 1 to generate the HTML document of FIG. 2A or 2B, which contains no extended tags.

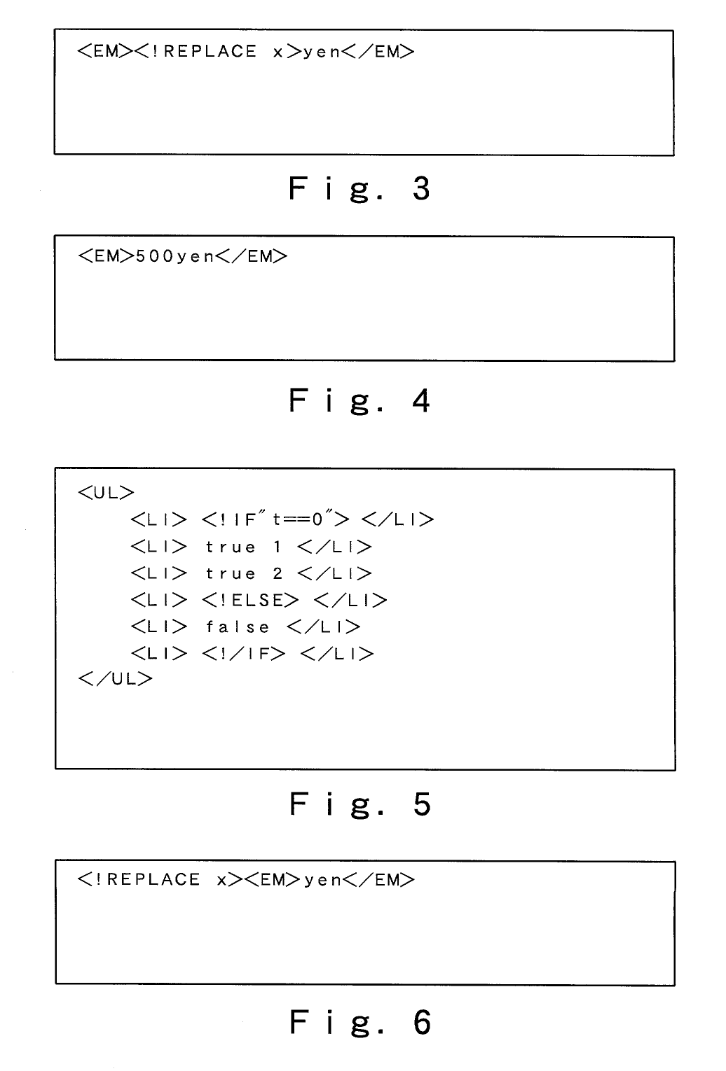

Furthermore, if the operator inputs the HTML document of FIG. 3, containing the second type extended tag, into the editor device 1, the editor device 1 will convert the input HTML document into the document shown in FIG. 6. The HTML document of FIG. 6 differs from the original intent of the operator.

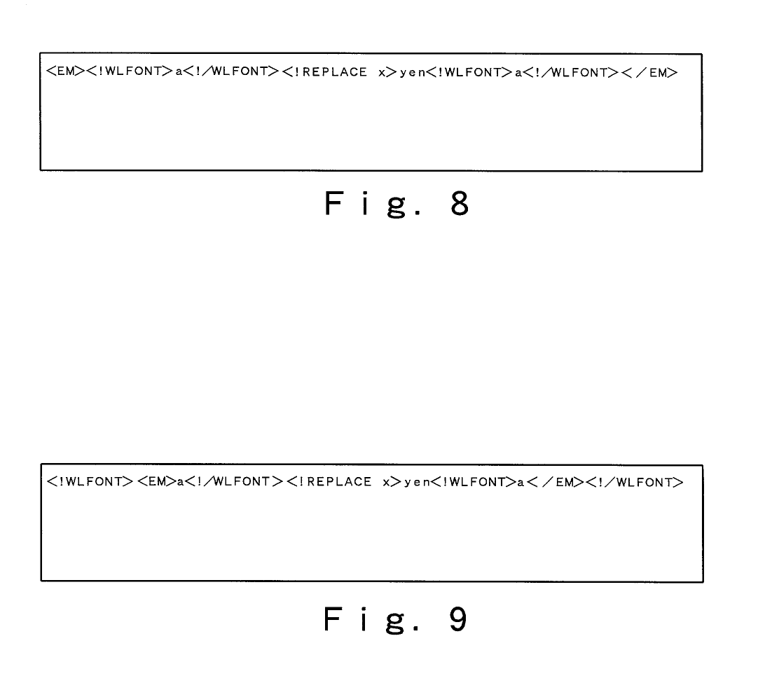

However, as described below, if the operator utilizes a combination <!WLFONT>a<!/WLFONT> arising from a predetermined identification extended tag pair <!WLFONT> and <!/WLFONT> and an arbitrary text (“a” for example) to create an HTML document shown in FIG. 8 and input the document into the editor device 1, the generation device 3 can acquire an HTML document which reflects the original intent of the operator.

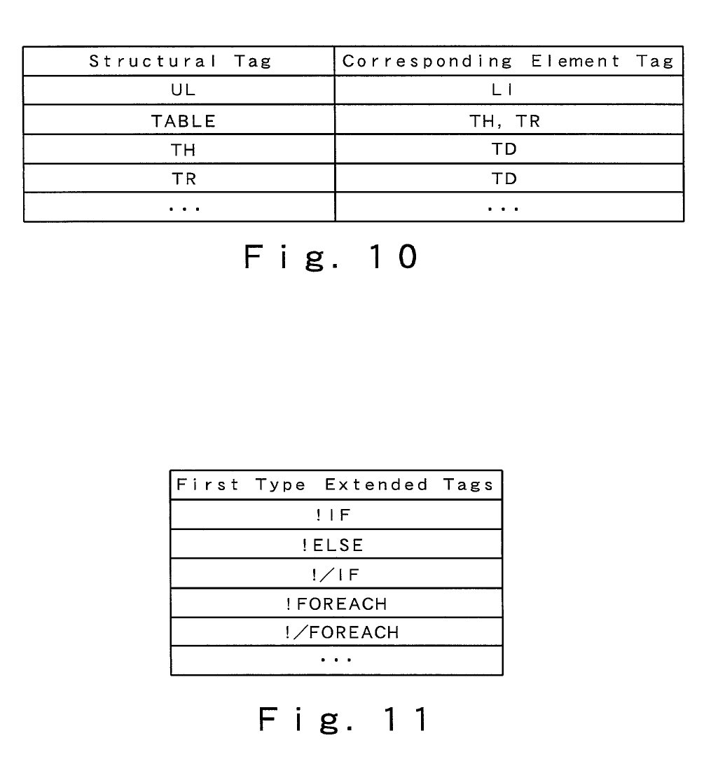

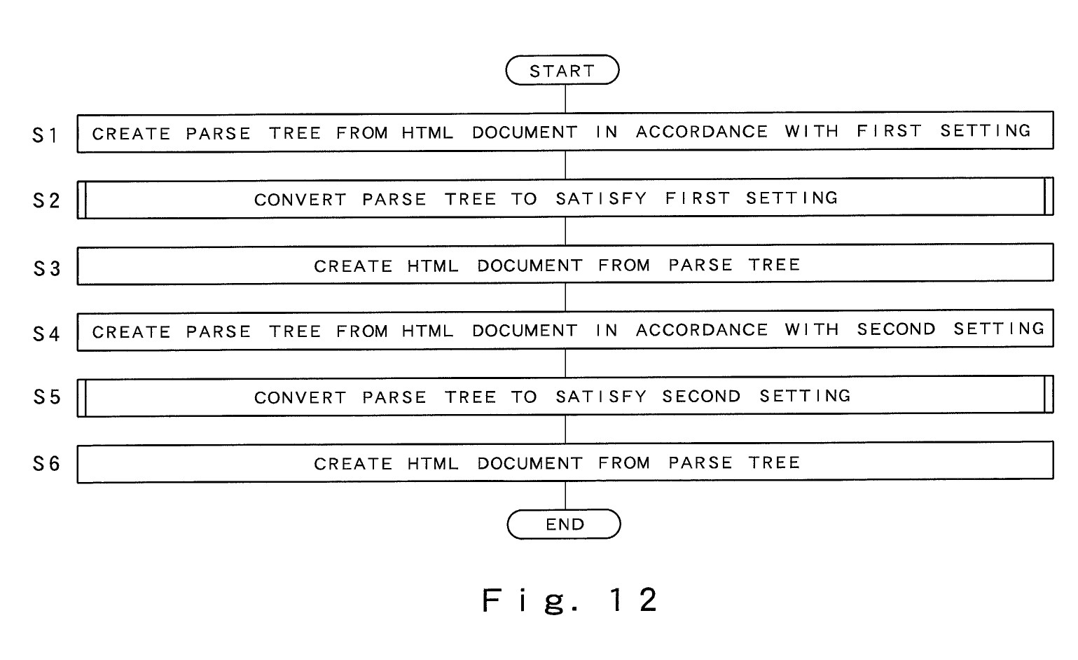

Although the editor device 1 converts the HTML document of FIG. 8 input by the operator to the document shown in FIG. 9, the generation device 3 can acquire the HTML document of FIG. 3 by performing the preprocessing described below on the HTML document of FIG. 9. Then the generation device 3 processes the extended tags in the HTML document of FIG. 3 to generate the HTML document of FIG. 4 which contains no extended tags.

The processing performed by the generation device 3 will be described below. The generation device 3 creates a parse tree by performing a syntax analysis (parsing) of the HTML document acquired from the editor device 1. The generation device 3 converts the thus created parse tree so as to satisfy predetermined specifications. The generation device 3 then creates an HTML document which reflects the original intent of the operator by converting the parse tree, which has been converted to satisfy the above predetermined specifications, into an HTML document. The processing to this point is called the preprocessing.

In addition, referring to the database 22 of the database device 2, the generation device 3 also processes any first type extended tags and second type extended tags included in the preprocessed HTML document to generate an HTML document without extended tags. The thus generated HTML document is transmitted to the server device 4 to be stored in its HDD.

A more detailed description of the preprocessing performed by the generation device 3 will be given below. The generation device 3 performs the preprocessing using the parse tree obtained by parsing the HTML document. In the parsing process, HTML tags and extended tags are classified as either type A or type B, as described below, and are then processed.

The type A tag provides a meaning at the tag location. The type A tag has no corresponding end tag because it is handled independently. The type B tag provides a meaning across a predetermined range. The range is defined by a start tag and an end tag. In such a case, the type B tags are used as a tag pair comprising the start tag and the end tag.

When the generation device 3 performs processing relating to the first type extended tag, it parses the HTML document in accordance with a predetermined first setting. The first setting treats HTML structural tags and the associated element tags shown below as type B tags, and treats extended tags and HTML tags except for the structural tags and associated element tags as type A tags.

The structural tags are typically used as a tag pair comprising a start tag and an end tag. It is assumed that element tags corresponding with the tag pair are listed in the region between the tag pair. The element tags are also usually used as a tag pair comprising a start tag and an end tag. Then the tag pair of the element tags can incorporate elements. For example, the tags <UL> and </UL> are structural tags. The element tags corresponding with these structural tags are the tag <LI>. In other words, it is assumed that in the region between <UL> and </UL> a list (elements) described by <LI> should be provided. The end tag </LI> corresponding with <LI> may be omitted.

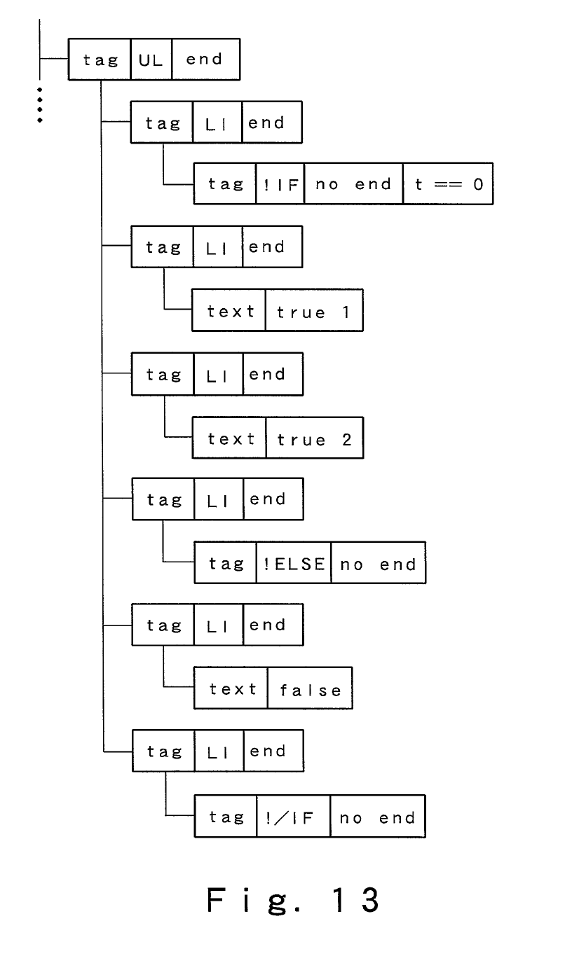

A table of structural tags and element tags is stored in the HDD of the generation device 3. FIG. 10 is a diagram showing a table of structural tags and element tags. As shown in FIG. 10, <UL> is a structural tag and the corresponding element tag is <LI>. Similarly, <TABLE> is a structural tag and the corresponding element tags are <TH> and <TR>. Moreover, the tags <TH> and <TR> are also structural tags, and the corresponding element tag is <TD>. By referring to the table of FIG. 10, the generation device 3 can recognize structural tags and element tags within an HTML document.

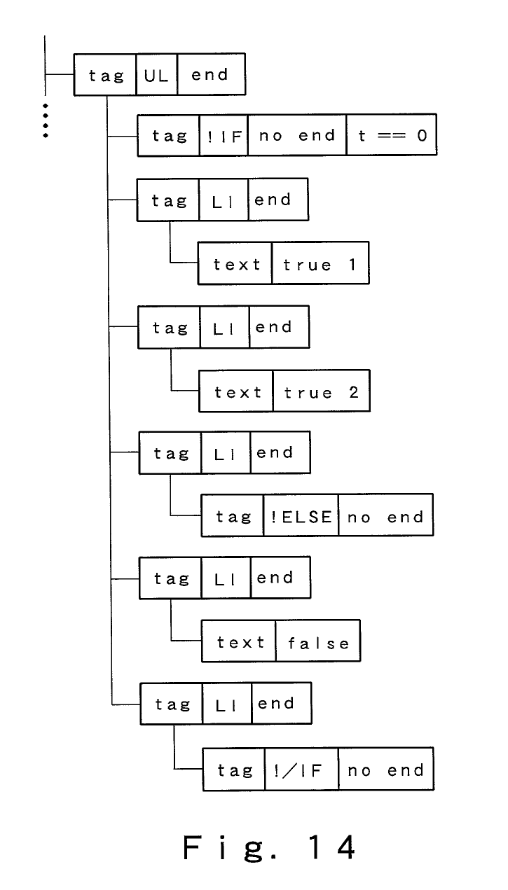

In addition, a table of first type extended tags is also stored in the HDD of the generation device 3. FIG. 11 is a diagram showing a table of first type extended tags. By referring to the table shown in FIG. 11, the generation device 3 can recognize tags such as <!IF>, <!ELSE>, <!/IF>, <!FOREACH> and <!/FOREACH> within an extended HTML document as first type extended tags.

When the generation device 3 performs processing relating to a second type extended tag, it parses the HTML document in accordance with a predetermined second setting. The second setting treats only the identification extended tag pair <!WLFONT> and <!/WLFONT> as a type B tag, and treats all other extended tags and HTML tags as type A tags. A table of identification extended tag pairs is stored in the HDD of the generation device 3, although the table is not shown in any of the drawings. By referring to this table, the generation device 3 can recognize the identification extended tag pairs within an extended HTML document.

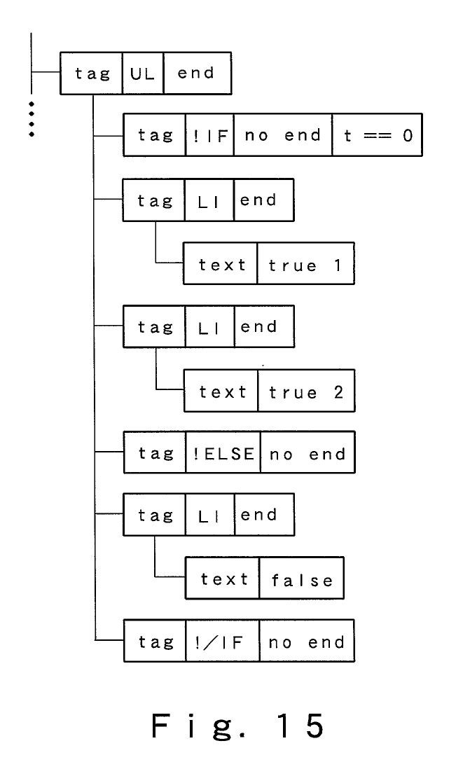

FIG. 12 is a flowchart showing the preprocessing of the generation device 3. Each of the steps shown in the drawing will be described below. Following commencement of the flowchart of FIG. 12, at S1, the generation device 3 creates a parse tree by parsing the extended HTML document acquired from the editor device 1 in accordance with the first setting. For example, an HTML document of FIG. 5 that has been converted by the editor device 1 is converted by the processing of S1 into the parse tree of FIG. 13.

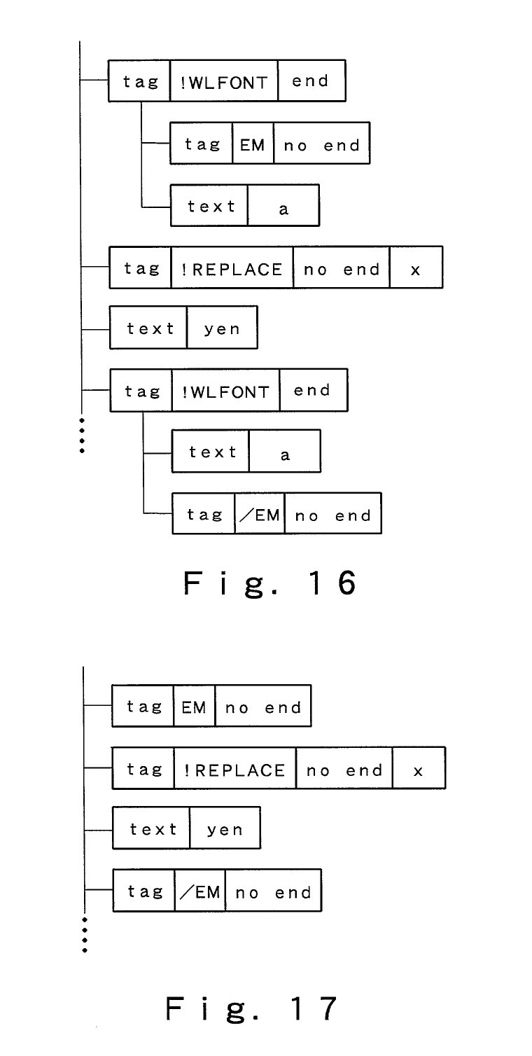

At the following step S2, the generation device 3 converts the parse tree created at S1 so as to satisfy the first setting. For example, the parse tree of FIG. 13 is converted (via an intermediate state shown in FIG. 14) to the parse tree shown in FIG. 15. The processing of S2 will be described in further detail below.

At the next step S3, the generation device 3 creates an HTML document, based on the parse tree converted at S2. For example, based on the parse tree of FIG. 15, the generation device 3 creates the substantially same HTML document as that shown in FIG. 1.

The processing from S1 to S3 described above, resolves any problems associated with first type extended tags. Problems associated with second type extended tags are then resolved by the processing of S4 onwards.

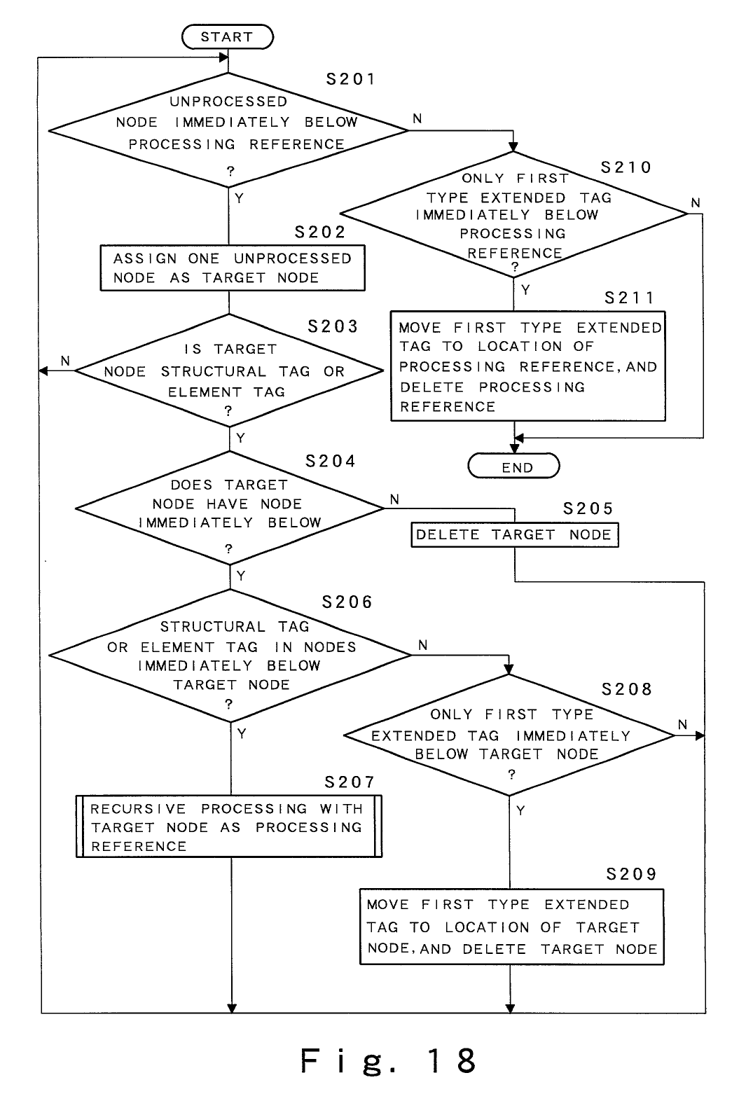

At S4, the generation device 3 creates a parse tree by parsing the HTML document created at S3 in accordance with the second setting. For example, an HTML document shown in FIG. 9 that has been converted by the editor device 1 includes no first type extended tags. Consequently the document is not converted by the processing from S1 to S3. As a result, at S4, the HTML document of FIG. 9 is processed. The processing of S4 converts the HTML document of FIG. 9 into the parse tree shown in FIG. 16.

At the following step S5, the generation device 3 converts the parse tree created at S4 so as to satisfy the second setting. For example, the parse tree of FIG. 16 is converted to the parse tree shown in FIG. 17. The processing of S5 will be described in further detail below.

At the following step S6, the generation device 3 creates an HTML document, based on the parse tree converted at S5. For example, based on the parse tree of FIG. 17, the generation device 3 creates the substantially same HTML document as that shown in FIG. 3.

Hereinafter, the processing of S2 shown in FIG. 12 will be described in detail. At S2 the generation device 3 sets the root of the parse tree created at S1 as a processing reference and then activates the flowchart of FIG. 18.

At the first step S201 following the commencement of the flowchart of FIG. 18, the generation device 3 judges whether an unprocessed node at the hierarchical level immediately below the processing reference exists or not. Then, the generation device 3 advances the processing to S202 if an unprocessed node is present. Without any unprocessed nodes, the processing alternatively proceeds to S210. For example, in the case of the parse tree shown in FIG. 13, if the processing reference is set at the root, the node immediately below the root is the node of the tag “UL”. If the “UL” node is unprocessed one, the processing proceeds to S202.

At S202, the generation device 3 sets one of the unprocessed nodes as a target node for processing. In the case of the parse tree of FIG. 13, the “UL” node becomes the target node.

At the following step S203, the generation device 3 judges whether or not the target node is either a structural tag or an element tag. Then, the generation device 3 advances the processing to S204 in the case that the target node is either a structural tag or an element tag. In other cases the processing alternatively returns to S201. In the parse tree shown in FIG. 13, in the case where the “UL” node is the target node, the generation device 3 recognizes the “UL” node as a structural tag by referring to the table of FIG. 10. In this case, the processing proceeds to S204.

At S204, the generation device 3 judges whether the target node has a node immediately below or not. Then the processing proceeds to S205 if the target node has no node immediately below. On the other hand the processing proceeds to S206 if the target node have a node immediately below. In the parse tree of FIG. 13, when the target node is the “UL” node, because the node has a node immediately below, the processing proceeds to S206. While the parse tree shown in FIG. 13 is processed, the processing of S205 is never executed. The processing of S205 will be described in more detail below with reference to a different parse tree.

At S206, the generation device 3 judges whether or not either a structural tag or an element tag exists at the node immediately below the target node. Then, the generation device 3 advances the processing to S207 in the case where either a structural tag or an element tag exist at the node immediately below the target node. In other cases the processing alternatively proceeds to S208. In the parse tree of FIG. 13, when the target node is the “UL” node, there are six “LI” nodes immediately below the “UL” node. Moreover, by referring to the table of FIG. 10, the generation device 3 identifies the “LI” nodes as element tags, and consequently advances the processing to S207.

At S207, the HTML document generation device 3 executes a recursive process with said target node as the processing reference hereinafter. For example, if the “UL” node is the target node, the generation device 3 calls the flowchart of FIG. 18 recursively with setting said “UL” node as the processing reference. The flowchart of FIG. 18 called at this step S207 is executed so as to process the next lower (inner) level in the recursive structure. When the processing of the flowchart of FIG. 18 is completed on this lower level, the processing of S207 ends. The processing then returns to S201.

In the following description, in order to distinguish each of the steps in the original level (level (1)) from each of the steps in the next lower level (level (2)), the step in the original level is described in the form (1)-S201, and the step in the next lower level is described in the form (2)-S201.

When the “UL” tag of the parse tree of FIG. 13 was set as the target node during the step (1)-S202 in the original level, in the steps of the next recursive level down (step (2)-S201 onwards), the “UL” node becomes the processing reference. Consequently, at the first occurrence of (2)-S201, because there are six unprocessed “LI” nodes below the “UL” node which is now the processing reference, the processing proceeds to (2)-S202.

At step (2)-S202, the leading node of the six “LI” nodes is set as the target node, and at the subsequent step (2)-S203, the tag of the target node is identified as an element tag, and the processing proceeds to (2)-S204. Subsequently, because the “LI” node has a “!IF” node immediately below, the processing proceeds to (2)-S206. At this step (2)-s206, a judgement is made that this node immediately below the “LI” node does not include a structural tag or an element tag. Thus the processing proceeds to (2)-S208.

At (2)-S208, the generation device 3 judges whether or not the node immediately below the target node set at (2)-S202 comprises only a node of a first type extended tag. Then, the generation device 3 advances the processing to (2)-S209 in the case where the node immediately below the target node comprises only a first type extended tag. In other cases the processing returns to (2)-S201. If the leading node of the six “LI” nodes shown in the parse tree of FIG. 13 is set as the target node, then the node immediately below this leading “LI” node comprises only the node of the first type extended tag “!IF”, and consequently the processing proceeds to (2)-S209.

At (2)-S209, the generation device 3 moves the first type extended tag immediately below the target node to the location of the target node, and deletes the actual target node. If the leading node of the six “LI” nodes shown in the parse tree of FIG. 13 is set as the target node, the node of the first type extended tag “!IF” immediately below this target node moves to a position immediately below the processing reference “UL” tag, as shown in FIG. 14.

By repeating the processing described above, the other first type extended tags, namely the nodes “!ELSE” and “!/IF”, also move to positions immediately below the processing reference “UL” node. In other words, when all six “LI” nodes have been processed, the parse tree shown in FIG. 15 is obtained. Following this processing, at step (2)-S201, the generation device 3 judges that there are no unprocessed nodes immediately below the processing reference “UL” node, and consequently advances the processing to (2)-S210.

At (2)-S210, the generation device 3 judges whether the node immediately below the processing reference comprises only a node of a first type extended tag or not. Then, the generation device 3 advances the processing to (2)-S211 in the case where the node immediately below the processing reference comprises only a first type extended tag. In all other cases the processing comes to end. In the sample parse tree shown in FIG. 15, the processing of S211 is not executed at any of the recursive levels. The processing of S211 is described below with reference to a different parse tree.

Following generation of the parse tree of FIG. 15, the processing of level (2) ends, as described above. The completion of the processing of level (2) corresponds to a completion of the processing of (1)-S207 of the original level. Consequently, the processing returns to (1)-S201. In this level (1), the root is the processing reference. After every node immediately below the root has been processed, all processing ends. That is, the processing of S2 in FIG. 12 ends.

At S3 of FIG. 12, the parse tree shown in FIG. 15 is converted to the substantially same HTML document as that shown in FIG. 1. In those cases where the HTML document obtained at S3 does not contain the identification extended tag <!WLFONT>, the extended HTML document obtained as a result of the processing performed at the steps S4 to S6 of FIG. 12 will be the same content as the extended HTML document obtained at S3, although this issue will be described in further detail later. Consequently, as a result of the preprocessing shown in FIG. 12, the substantially same extended HTML document as that of FIG. 1 is obtained.

Following completion of this preprocessing, and referring to the database 22 of the database device 2, the generation device 3 processes first type extended tags and second type extended tags within the extended HTML document to generate an HTML document including no extended tags. For example, based on the extended HTML document of FIG. 1, the generation device 3 will generate either the HTML document of FIG. 2A, or that of FIG. 2B. In this generation process, if the value of the variable t in the database 22 is 0, the generation device 3 will generate the HTML document of FIG. 2A. In contrast, if the value of the variable t is not 0, the generation device 3 will generate the HTML document of FIG. 2B.

As follows is a further description of the processing of S2 (the processing of FIG. 18 described above) from the preprocessing flowchart shown in FIG. 12, with reference to a different parse tree. First is a description of the extended HTML document, which will be parsed to become this parse tree. FIG. 19 is a diagram showing a sample HTML document. First, the operator uses the editor device 1 to input the HTML document of FIG. 19.

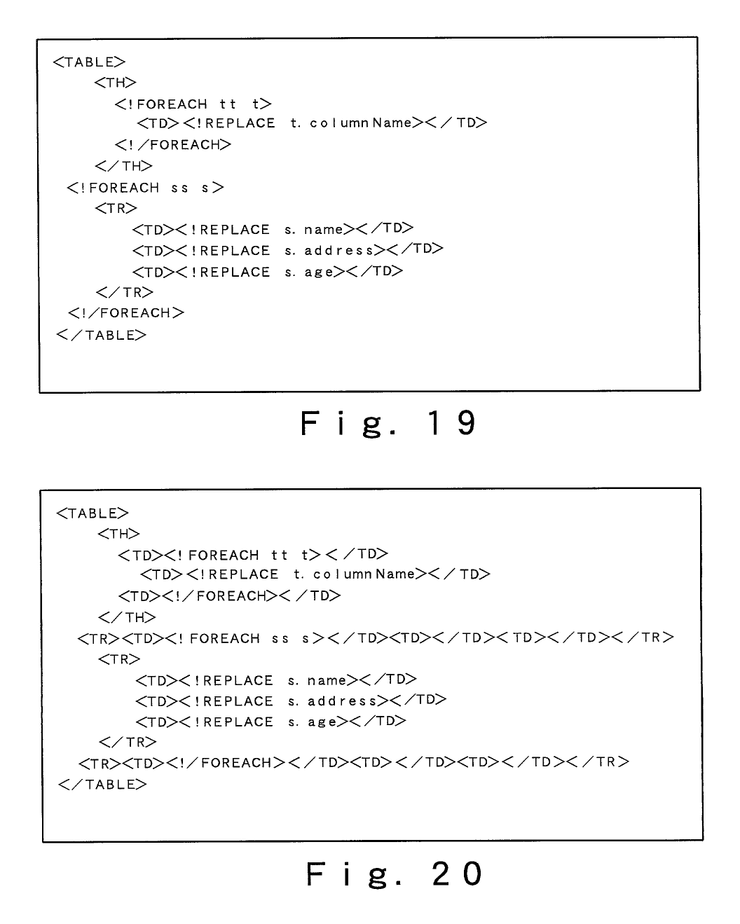

The editor device 1 recognizes that the structural tag pair <TABLE> and </TABLE> incorporates the tag pair <TH> and </TH>, as well as the tag pair <TR> and </TR> which is positioned after the tag pair <TH> and </TH>. In addition, the editor device 1 also recognizes that the tag pair <TH> and </TH>, and the tag pair <TR> and </TR> each incorporates a tag pair <TD> and </TD>. As a result, the editor device 1 determines that tag pairs are missing from before and after the tags <! FOREACH> and <!/FOREACH> in the HTML document, and consequently adds in supplementary tag pairs <TD> and </TD> (as well as <TR> and </TR>) against the intent of the operator. As a result, the HTML document of FIG. 19 is converted to the document shown in FIG. 20.

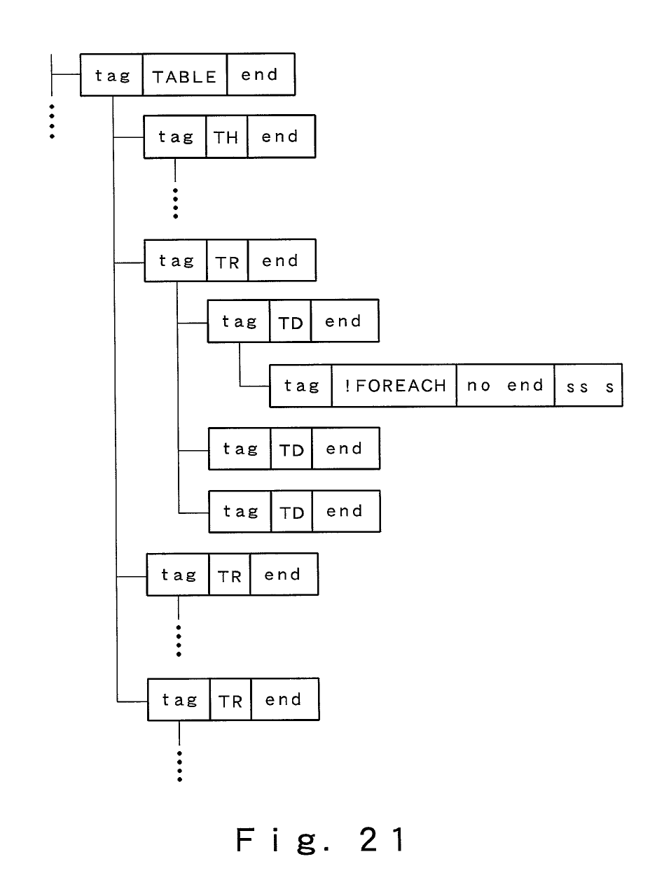

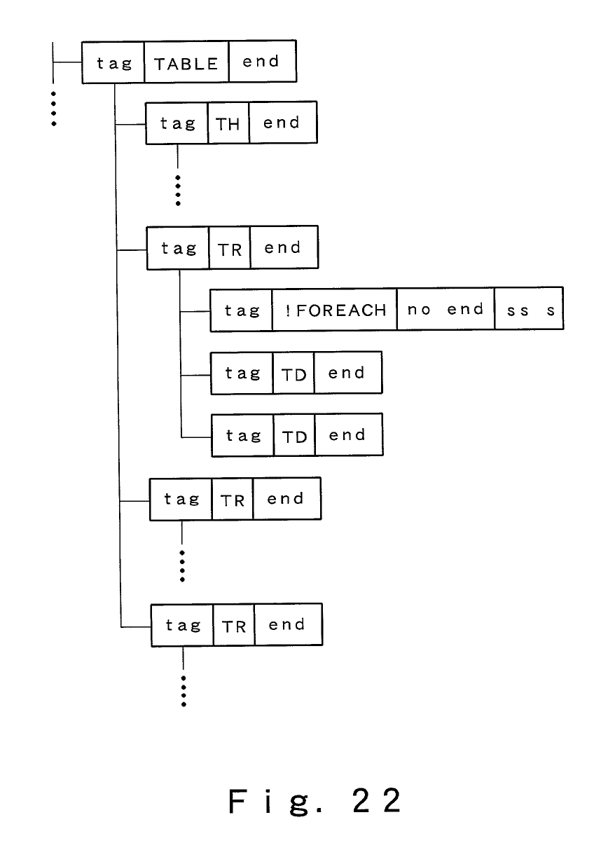

Subsequently, the generation device 3 acquires the HTML document of FIG. 20 and performs the preprocessing shown in FIG. 12. At step SI of FIG. 12, the HTML document of FIG. 20 is converted into the parse tree shown in FIG. 21. At step S2 of FIG. 12, namely in the flowchart of FIG. 18, the parse tree of FIG. 21 is processed as described below.

At the step (1)-S201 of FIG. 18, the processing reference is set at the root. Immediately below the root is an unprocessed node “TABLE”. As a result, the processing proceeds to (1)-S202. At (1)-S202, the “TABLE” node is set as the target node.

At the next step (1)-S203, because the “TABLE” node is a structural tag, the generation device 3 advances the processing to (1)-S204. At (1)-S204, because the “TABLE” node has a node immediately below, the generation device 3 advances the processing to (1)-S206.

As shown in FIG. 21, a single “TH” node and three “TR” nodes exist immediately below the “TABLE” tag. These “TH” and “TR” tags are structural tags. As a result, at (1)-S206 the generation device 3 advances the processing to (1)-S207.

At step (1)-S207, the generation device 3 assigns the target node in the level (1), namely the “TABLE” node, as the processing reference for the level (2), and then calls the processing of FIG. 18 for this level (2) in a recursive manner. At (2)-S201, if there is an unprocessed node immediately below the processing reference “TABLE” node, the generation device 3 advances the processing to (2)-S202. As shown in FIG. 21, a single “TH” node and three “TR” nodes exist immediately below the processing reference “TABLE” node. In the diagram, although details of those nodes immediately below the leading “TR” node are shown, for the sake of simplicity, the corresponding details of the “TH” node and the last two “TR” nodes are omitted. The following description assumes that the processing relating to the “TH” node has already been completed, and that the three “TR” nodes remain unprocessed.

At (2)-S202, the generation device 3 assigns the leading node of the three “TR” nodes as the target node. At the next step (2)-S203, the generation device 3 identifies the “TR” tag of the target node as a structural tag, and advances the processing to (2)-S204. This “TR” target node has three “TD” nodes immediately below. As a result, at step (2)-S204, the generation device 3 advances the processing to (2)-S206. Because the three “TD” tags are element tags, at (2)-S206 the generation device 3 advances the processing to (2)-S207.

At (2)-S207, the generation device 3 assigns the target node in the level (2), namely the “TR” node, as the processing reference for the next recursive level down, namely level (3), and then calls the processing of FIG. 18 for this level (3) in a recursive manner. At the first occurrence of (3)-S201, the generation device 3 judges that an unprocessed node exists immediately below the processing reference “TR” node, and advances the processing to (3)-S202.

At (3)-S202, the generation device 3 assigns the leading node of the three “TD” nodes as the target node. At the next step (3)-S203, the generation device 3 identifies the target node as an element tag, and advances the processing to (3)-S204. This “TD” target node has a “!FOREACH” node immediately below. As a result, at step (3)-S204, the generation device 3 advances the processing to (3)-S206.

The target node has only the first type extended tag “!FOREACH” node immediately below, and has no nodes comprising structural tags or element tags. As a result, at (3)-S206, the generation device 3 advances the processing to (3)-S208.

At (3)-S208, the generation device 3 judges whether the node immediately below the target node comprises only a node of a first type extended tag or not. Then, the generation device 3 advances the processing to (3)-S209 in the case where the node immediately below the target node comprises only a first type extended tag. In other cases the processing returns to (3)-S201. When the node immediately below the target “TD” node comprises only the node of the first type extended tag “!FOREACH,” the processing proceeds to (3)-S209.

At (3)-S209, the generation device 3 moves the “!FOREACH” node immediately below the “TD” target node, to the location of the “TD” target node, and deletes the actual target node. As a result of this processing, the parse tree of FIG. 21 is converted to that of FIG. 22. The processing subsequently returns to (3)-S201.

At this point, processing of the “!FOREACH” node is complete, but the two “TD” nodes on the same level as this “!FOREACH” node remain unprocessed. Consequently, at the next occurrence of (3)-S201, the generation device 3 advances the processing to (3)-S202.

At (3)-S202, the generation device 3 assigns the leading node of the two “TD” nodes as the target node. This new target “TD” node is an element tag. As a result, at (3)-S203, the generation device 3 advances the processing to (3)-S204. This target “TD” node has no nodes immediately below. Consequently, at (3)-S204 the generation device 3 advances the processing to (3)-S205.

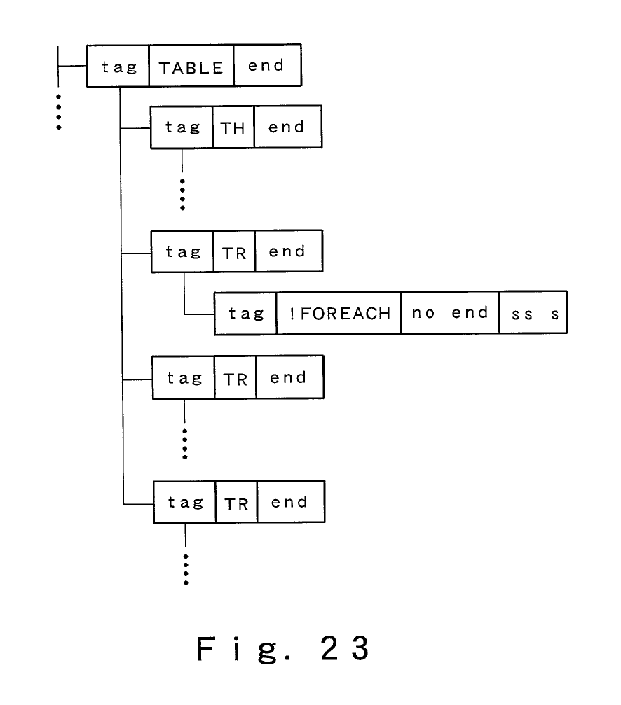

At (3)-S205, the generation device 3 deletes the target node, and then returns the process to (3)-S201. In other words, once the target “TD” node has been deleted, the processing returns to (3)-S201. The subsequent processing from (3)-S201 onwards results in the final “TD” node below the processing reference “TR” node being deleted in a similar manner. At this point, the parse tree of FIG. 23 is obtained. As shown in FIG. 23, the leading node of the three “TR” nodes (namely, the processing reference) has only the “!FOREACH” node immediately below. As described above, this “!FOREACH” node has already been processed. Consequently, at (3)-S201 the generation device 3 judges that there are no unprocessed nodes immediately below the processing reference, and causes the process to branch off to step (3)-S210.

At (3)-S210, the generation device 3 judges whether the node immediately below the processing reference comprises only a node of a first type extended tag or not. Then, the generation device 3 advances the processing to (3)-S211 in the case where the node immediately below the processing reference comprises only a first type extended tag. In other cases the processing of the level (3) comes to end. AS shown in the parse tree of FIG. 23, the leading node of the three “TR” nodes (namely, the processing reference) has only the node of the first type extended tag “!FOREACH” immediately below. As a result, at (3)-S210 the generation device 3 advances the processing to (3)-S211.

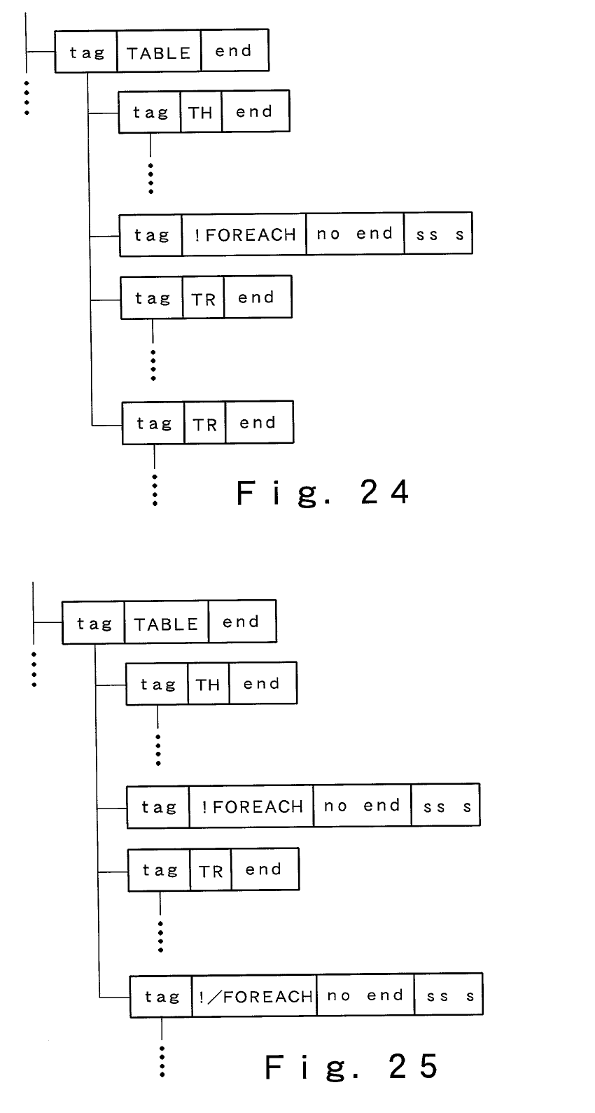

At (3)-S211, the generation device 3 moves the node of the first type extended tag immediately below the processing reference to the location of the processing reference, and deletes the actual processing reference. The generation device 3 subsequently terminates the processing (of the level (3)). In the sample parse tree shown in FIG. 23, the “!FOREACH” node moves to the location of the processing reference “ TR” node, this processing reference “TR” node is deleted, and the parse tree of FIG. 24 is obtained. The processing of the level (3) is then complete.

This completion of the processing of the level (3) corresponds to the completion of step (2)-S207 in the one recursive level above. Consequently, the processing returns to (2)-S201. In the sample parse tree of FIG. 24, at level (2), the “TABLE” node is the processing reference. As described above, the “!FOREACH” node immediately below this processing reference”TABLE” node has already been processed. However the two “TR” nodes on the same level as this “!FOREACH” node remain unprocessed.

By sequentially processing each of these unprocessed nodes, the generation device 3 converts the parse tree of FIG. 24 into the parse tree shown in FIG. 25. The generation device 3 then terminates the processing of the level (2).

This completion of the processing of the hierarchy (2) corresponds to the completion of step (1)-S207 in the one recursive level above. Consequently, the processing returns to (1)-S201. At level (1), the root is the processing reference. In the example shown in FIG. 25, only the “TABLE” node is shown immediately below the root. This “TABLE” node has been processed in the manner described above. Thus the process branches off to(1)-S210. Immediately below this “STABLE” node, there are other nodes in addition to the first type extended tag nodes ((1)-S210: No). Consequently, the processing of the level (1) ends. The completion of the processing of the level (1) corresponds to the completion of the processing of S2 of FIG. 12.

The parse tree of FIG. 25 is then converted to the extended HTML document of FIG. 19 at step S3 of FIG. 12. In those cases where the extended HTML document obtained at S3 does not contain the identification extended tag <!WLFONT>, the extended HTML documents obtained as a result of the processing performed at the steps S4 to S6 of FIG. 12 will be of the same content as the extended HTML document obtained at S3, although this issue will be described in further detail below. Consequently, as a result of the preprocessing shown in FIG. 12, an HTML document of the same content as FIG. 19 is obtained.

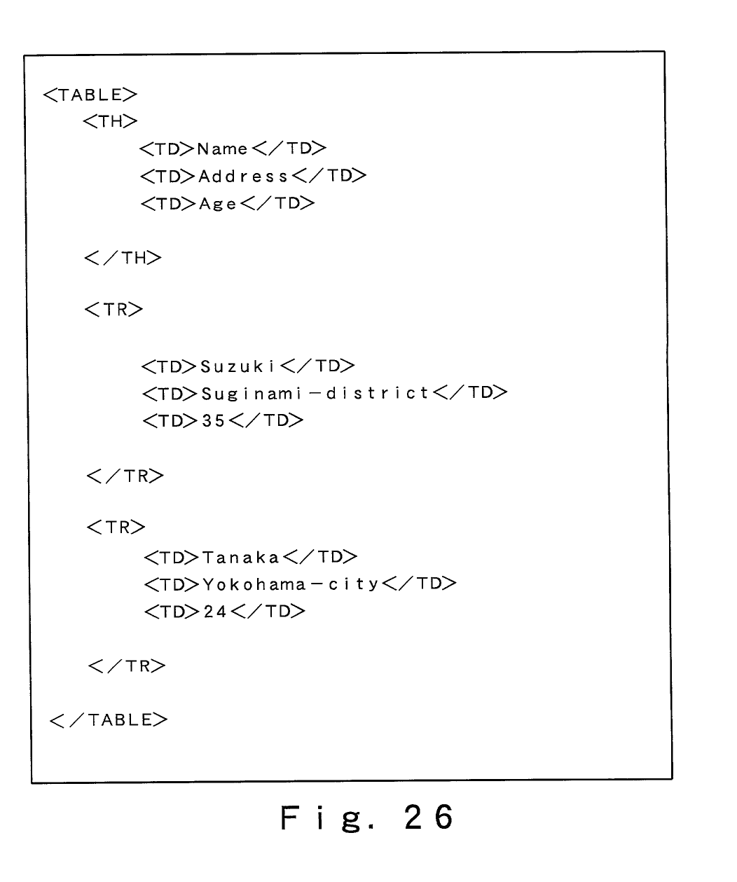

Following completion of this preprocessing, referring to the database 22 of the database device 2, the generation device 3 processes the extended tags within the extended HTML document, and generates an HTML document which contains no extended tags. When this document generation processing is performed based on the HTML document of FIG. 19, if the value of tt in the database is {{columnName→“Name”}, {columnName→“Address”}, {columnName→“Age”}} and the value of ss is {{name→“Suzuki”, address→“Suginami-district”, age→“35”}, {name→“Tanaka”, address→“Yokohama-city”, age→“24”}}, the HTML document of FIG. 26 is generated.

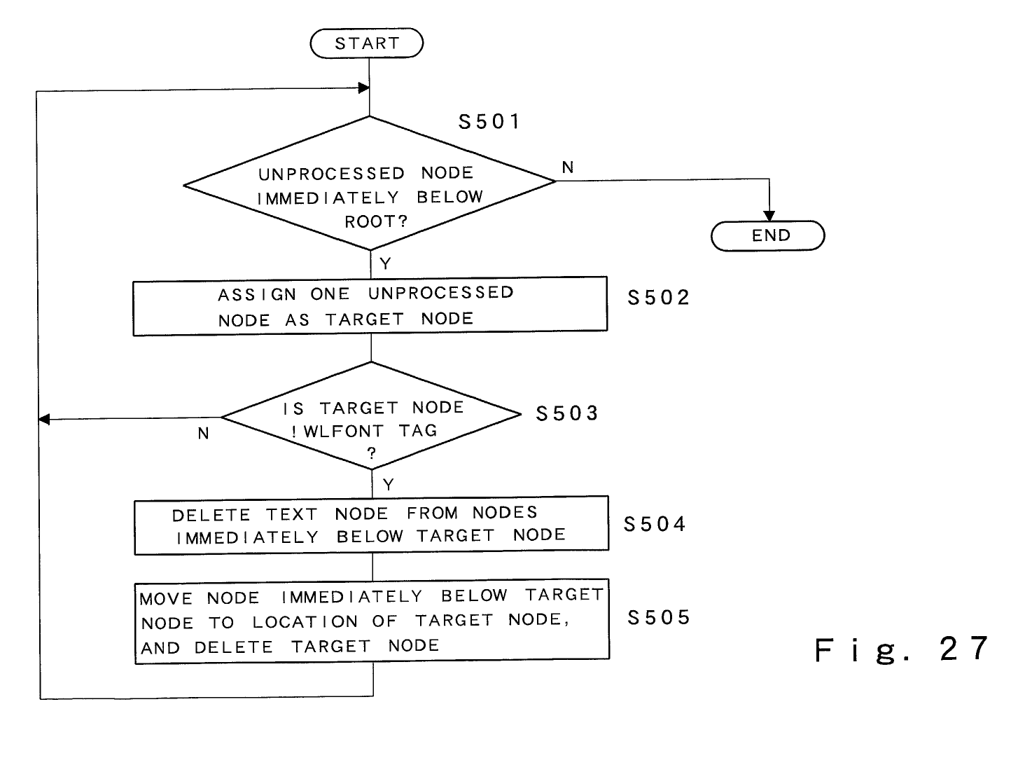

A detailed description of the processing at S5 of the preprocessing shown in FIG. 12 will be given. At this step S5, the generation device 3 processes the parse tree created at S4 in accordance with the flowchart of FIG. 27. The flowchart of FIG. 27 will be described below using the parse tree of FIG. 16 created at S4 as an example.

At the first step S501 following commencement of the flowchart of FIG. 27, the generation device 3 judges whether an unprocessed node is present immediately below the root of the parse tree or not. Then, the generation device 3 advances the processing to S502 in the case where an unprocessed node is present. In other cases the processing comes to end. The root of the parse tree of FIG. 16 has four nodes positioned immediately below. Namely, a node comprising the identification extended tag “!WLFONT”, a node comprising a second type extended tag “!REPLACE”, a node with the text “yen”, and another node comprising the identification extended tag “!WLFONT” are all connected immediately below the root. When the flowchart of FIG. 27 is activated, each of these nodes immediately below the root is initially in an unprocessed state. As a result, the generation device 3 advances the processing to S502.

At S502, the generation device 3 sets the leading node of the unprocessed nodes as the target node. In the parse tree of FIG. 16, because all four nodes immediately below the root are unprocessed, then the leading node, namely the identification extended tag “!WLFONT”, becomes the target node.

At the next step S503, the generation device 3 determines whether the target node is a node comprising the identification extended tag “!WLFONT” or not. Then, the generation device 3 advances the processing to S504 in the case where the target node is a node comprising the identification extended tag “!WLFONT.” In other cases the processing returns to S501.

At S504, the text node is deleted from those nodes positioned immediately below the target node. If the target node is the node of the “!WLFONT” tag, the node of the text “a” positioned immediately below, is deleted. As a result, only the node of the tag “EM” remains immediately below the “!WLFONT” node.

At the next step S505, the node immediately below the target node is moved to the location of the target node, and the actual target node itself is deleted. Then, the generation device 3 causes the processing to return to S501. As a result of the processing at S505, the “EM” node remaining immediately below the “!WLFONT” node moves to the location of the “!WLFONT” node. The actual “!WLFONT” node itself is deleted. Consequently, the root of the processed parse tree has the “EM” node, the “!REPLACE” node, the “yen” node, and the “!WLFONT” node immediately below. The process then returns to S501.

In subsequent processing, the “EM” node is treated as already processed, and the “!REPLACE” node, the “yen” node, and the “!WLFONT” node remain unprocessed. Consequently, at the second occurrence of step S501, an unprocessed node is identified as being present, and the processing proceeds to S502. Then, at S502, the “!REPLACE” node becomes the target node. Consequently, at the next step S503, the generation device 3 determines that the target node is not a “!WLFONT” node, and causes the processing to return to S501.

In subsequent processing, the “EM” node and the “!REPLACE” node are treated as already processed, and the “yen” node, and the “!WLFONT” node remain unprocessed. Consequently, at the third occurrence of step S501, an unprocessed node is again identified as being present, and the processing proceeds to S502. Then, at S502, the “yen” node becomes the target node. Consequently, at the next step S503, the generation device 3 judges that the target node is not a “!WLFONT” node, and causes the processing to return to S501.

In subsequent processing, only the final “!WLFONT” node remains unprocessed. Consequently, at the fourth occurrence of step S501, the generation device 3 advances the processing to S502, and then sets the “!WLFONT” node as the target node at step S502.

Then, because the target node is the node “!WLFONT” (S503: Yes), the generation device 3 deletes the node comprising the text “a” which is found immediately below the target node (S504). Then, the generation device 3 moves the remaining “/EM” node to the location of the “!WLFONT” node, and then deletes the actual “!WLFONT” node (S505). As a result, the parse tree of FIG. 17 is obtained. Then, the generation device 3 causes the processing to return to S501. At this fifth occurrence of step S501 there are no unprocessed nodes immediately below the root. Thus the generation device 3 terminates the process.

This completion of the processing of FIG. 27 corresponds to a completion of the processing of S5 of FIG. 12. The parse tree of FIG. 17, which is obtained as a result of the processing of S5 from FIG. 12, is subsequently converted to the extended HTML document of FIG. 3 at step S6 of FIG. 12. Consequently, as a result of the preprocessing shown in FIG. 12, an extended HTML document which reflects the intent of the operator is generated.

Following completion of this preprocessing, referring to the database 22 of the database device 2, the generation device 3 processes any extended tags within the extended HTML document to generate an HTML document without extended tags. In this generation process, if the value of the variable x in the database 22 is 500, the extended HTML document of FIG. 3 will be converted to the HTML document of FIG. 4.

As described above, in the case where the operator wishes to create an extended HTML document such as that shown in FIG. 3, in which a second type extended tag is used in combination with a character style tag, an HTML document such as that shown in FIG. 8, which utilizes an identification extended tag pair and an arbitrary text “<!WLFONT>a<!/WLFONT>”, is input into the editor device 1.

As a result, the editor device 1 converts the extended HTML document of FIG. 8 to the document shown in FIG. 9, but the generation device 3 analyzes the extended HTML document of FIG. 9 correctly, and is able to generate the HTML document of FIG. 4.

According to a computer readable medium containing the HTML document generation program, the HTML document generation method, and the HTML document generation device, which are all of the present invention and constructed in the manner described above, even if an HTML editor converts an HTML document containing extended tags in a way which is contrary to the intent of the operator, the converted HTML document is still recognized in the way the operator intended. Consequently, an HTML document which contains extended tags is processed correctly, and an HTML document without extended tags which reflects the original intent of the operator is generated in accordance with the specifications of the extended tags.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A computer readable medium containing an HTML document generation program controlling a computer to execute:
a step of reading an HTML document including a first type extended tag which is defined so that said extended tag itself does not develop into a text;
a step of recognizing said first type extended tag included in the read HTML document;
a step of ignoring an HTML tag pair for bracketing an element in a predetermined form therebetween included in the read HTML document which encloses only an element described by said first type extended tag or encloses no elements; and
a step of generating an HTML document whose tags are all prescribed in HTML syntax, in accordance with specifications of said first type extended tag included in the read HTML document.

2. A computer readable medium containing an HTML document generation program controlling a computer to execute:
a step of reading an HTML document including a second type extended tag which is defined so that said second type extended tag itself develops into a text, and being prescribed such that, with respect to said second type extended tag bracketed with a pair of HTML start and end tags relating to a character style, an arbitrary text is added immediately after said start tag relating to the character style and immediately prior to said end tag relating to the character style, and also prescribed such that each set of said tag relating to the character style and said arbitrary text is enclosed by a predetermined identification extended tag pair;
a step of recognizing said tag relating to the character style;
a step of ignoring elements enclosed by said identification extended tag pair except for said tag relating to the character style and also ignoring said identification extended tag itself; and
a step of generating an HTML document whose tags are all prescribed in HTML syntax, in accordance with specifications of said second type extended tag included in the read HTML document.

3. A computer readable medium containing an HTML document generation program controlling a computer to execute:
a step of reading an HTML document incorporating an extended tag defining processing for updating an HTML document;
a step of updating said HTML document based on said processing defined by said extended tag included in the read HTML document; and
a step of outputting the updated HTML document as an HTML document whose tags are all prescribed in HTML syntax.

4. A method of generating an HTML document comprising:
a step of reading an HTML document incorporating an extended tag defining processing for updating an HTML document;
a step of updating said HTML document based on said processing defined by said extended tag included in the read HTML document; and
a step of outputting the updated HTML document as an HTML document whose tags are all prescribed in HTML syntax.

5. An HTML document generation device comprising:
a computer; and
a computer readable medium containing an HTML document generation program controlling the computer to execute:
a step of reading an HTML document incorporating an extended tag defining processing for updating an HTML document,
a step of updating said HTML document based on said processing defined by said extended tag included in the read HTML document, and
a step of outputting the updated HTML document as an HTML document whose tags are all prescribed in HTML syntax.
